(19) United States
(12) Patent Application Publication
(10) Pub. No.: US 2013/0179139 A1
(43) Pub. Date: Jul. 11, 2013

(54) METHOD FOR APPLYING VIRTUAL PERSON AND PORTABLE ELECTRONIC DEVICE FOR USE WITH THE METHOD

(71) Applicant: Fu-Wen Lee, Hsinchu (TW)

(72) Inventor: Fu-Wen Lee, Hsinchu (TW)

(73) Assignees: Yi-Ming Chiu, Taipei (TW); Fu-Wen Lee, Hsinchu (TW)

(21) Appl. No.: 13/731,059

(22) Filed: Dec. 30, 2012

(30) Foreign Application Priority Data
Jan. 5, 2012 (TW) 101100421

(51) Int. Cl. G06F 19/12

(52) U.S. Cl. CPC G06F 19/12
USPC 703/11

(57) ABSTRACT

Provided is a method for applying a virtual person and for use with a portable electronic device connected to a cloud server via a communication chain, wherein the cloud server executes a virtual person artificial intelligence simulation program. The portable electronic device displays a virtual person and detects and collects a user's biological feature signals and use status signals by a plurality of sensors of the portable electronic device, and then sends the signals to the cloud server. The virtual person artificial intelligence simulation program processes the signals and then outputs a plurality of response signals in response to the signals. The portable electronic device outputs and displays a plurality of animation frames and/or sounds which are performed by the virtual person and/or outputs vibrations in response to the response signals.

The current application claims a foreign priority to the application of Taiwan 101100421 filed on Jan. 5, 2012.

### FIELD OF THE INVENTION

The present invention relates to biological simulation methods and devices, and more particularly, to a method for applying a virtual person and a portable electronic device for use with the method.

### BACKGROUND OF THE INVENTION

A prior art related to augmented reality system for biological physiological feature recognition discloses that an augmented reality system, which is capable of capturing an identification signal pertaining to biological physiological features so as for the identification signal to function as an instruction for starting or executing an augmented reality program, comprises a recognition device, a screen, and a processor, wherein the processor is electrically connected to the recognition device and the screen, and the processor has a physiological feature recognition module. As soon as the recognition device retrieves a physiological feature recognition signal from a human being and has the signal analyzed with a physiological feature recognition module, the processor executes an augmented reality program on the screen.

Another prior art related to robot autonomic emotional expression device discloses a robot autonomic emotional expression device, comprising: a sensing unit; a user emotion recognition unit recognizing the user's present emotional state after receiving sensing information from the sensing unit, and calculating the user's emotional intensity according to the present emotional state of the user; a robot emotion generation unit generating the emotional state of the robot itself according to the user's emotional intensity; a behavior fusion unit calculating a plurality of output behavior weights via a neural fuzzy network according to the user's emotional intensity and a rule table; and a robot response unit expressing the robot's emotional behavior according to the output behavior weights and the robot's emotional state.

Although the prior arts are about capturing an identification signal pertaining to biological physiological features and about virtual person artificial intelligence, they do not disclose how to simulate application of a virtual person, using the robust computational capacity of a cloud server.

In view of the increasingly wide use of portable electronic devices and the trend toward cloud computing, the inventor of the present invention conceived room for improvement in the prior art and thus conducted extensive researches and experiments according to the inventor's years of experience in the related industry, and finally developed a method for applying a virtual person and a portable electronic device for use with the method, to thereby not only combine a sophisticated virtual person artificial intelligence simulation program with a portable electronic device by means of the robust computational capacity of a cloud server, but also enable the portable electronic device to simulate a person alive and capable of interacting with users.

### SUMMARY OF THE INVENTION

It is an objective of the present invention to provide a method which applies a virtual person, operates in conjunction with a portable electronic device, combines a sophisticated virtual person artificial intelligence simulation program with the portable electronic device by means of the robust computational capacity of a cloud server, and enables the portable electronic device to simulate a person alive and capable of interacting with users.

Another objective of the present invention is to provide a portable electronic device for executing the aforesaid method to thereby not only combine a sophisticated virtual person artificial intelligence simulation program with a portable electronic device by means of the robust computational capacity of a cloud server, but also enable the portable electronic device to simulate a person alive and capable of interacting with users.

In order to achieve the above and other objectives, the present invention provides a method for applying a virtual person and for use with a portable electronic device, wherein the portable electronic device is connected to a cloud server via a communication chain, and the cloud server executes a virtual person artificial intelligence simulation program. The method comprises the steps of: displaying a virtual person by the portable electronic device; detecting and collecting a plurality of biological feature signals of a user of the portable electronic device and a plurality of use status signals of the portable electronic device by a plurality of sensors of the portable electronic device; sending, by the portable electronic device, the biological feature signals and the use status signals to the cloud server via the communication chain; receiving the biological feature signals and the use status signals by the cloud server, processing the biological feature signals and the use status signals by the virtual person artificial intelligence simulation program of the cloud server, outputting a plurality of response signals in response to the biological feature signals and the use status signals, followed by sending, by the cloud server, the response signals to the portable electronic device via the communication chain; and receiving and processing the response signals by the portable electronic device, followed by outputting and displaying, by the portable electronic device, a plurality of animation frames and/or sounds which are performed by the virtual person and/or outputting vibrations in response to the response signals.

In order to achieve the above and other objectives, the present invention further provides a portable electronic device, comprising: a plurality of sensors; a display unit, a vibration unit and a speaker; a communication module for connection with a communication chain; a virtual person simulation program; and a processor for executing the virtual person simulation program to thereby perform the steps of: displaying a virtual person on the display unit; detecting and collecting a plurality of biological feature signals of a user of the portable electronic device and a plurality of use status signals of the portable electronic device by the sensors; sending, by the communication module, the biological feature signals and the use status signals to a cloud server to thereby allow the cloud server to receive the biological feature signals and the use status signals, such that a virtual person artificial intelligence simulation program of the cloud server processes the biological feature signals and the use status signals before outputting a plurality of response signals in response to the biological feature signals and the use status signals, and then the cloud server sends the response signals to the portable electronic device via the communication chain; and receiving and processing the response signals by the communication module, followed by displaying on the display unit a plurality of animation frames which are performed by the virtual person in response to the response signals, and/or outputting a sound from the speaker, and/or outputting a vibration from the vibration unit.

### BRIEF DESCRIPTION OF THE DRAWINGS

Objectives, features, and advantages of the present invention are hereunder illustrated with specific embodiments in conjunction with the accompanying drawings, in which:

FIG. 1 is a schematic view of an application environment for a method for applying a virtual person according to the present invention;

FIG. 2 is a schematic view of application of the method for applying a virtual person to a portable electronic device according to the present invention;

FIG. 3 is a flowchart of the method for applying a virtual person according to the present invention; and

FIG. 4 is a block diagram of the portable electronic device according to the present invention.

### DETAILED DESCRIPTION OF THE EMBODIMENTS

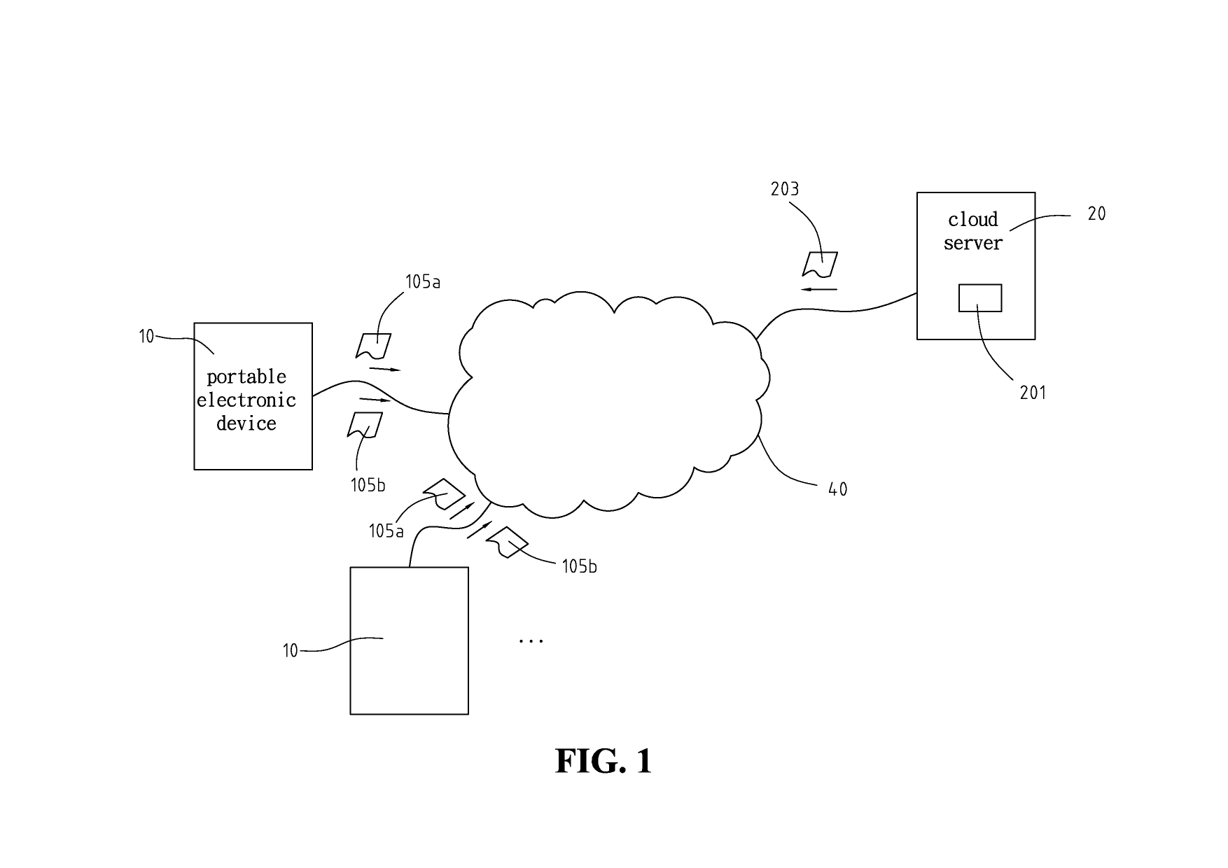

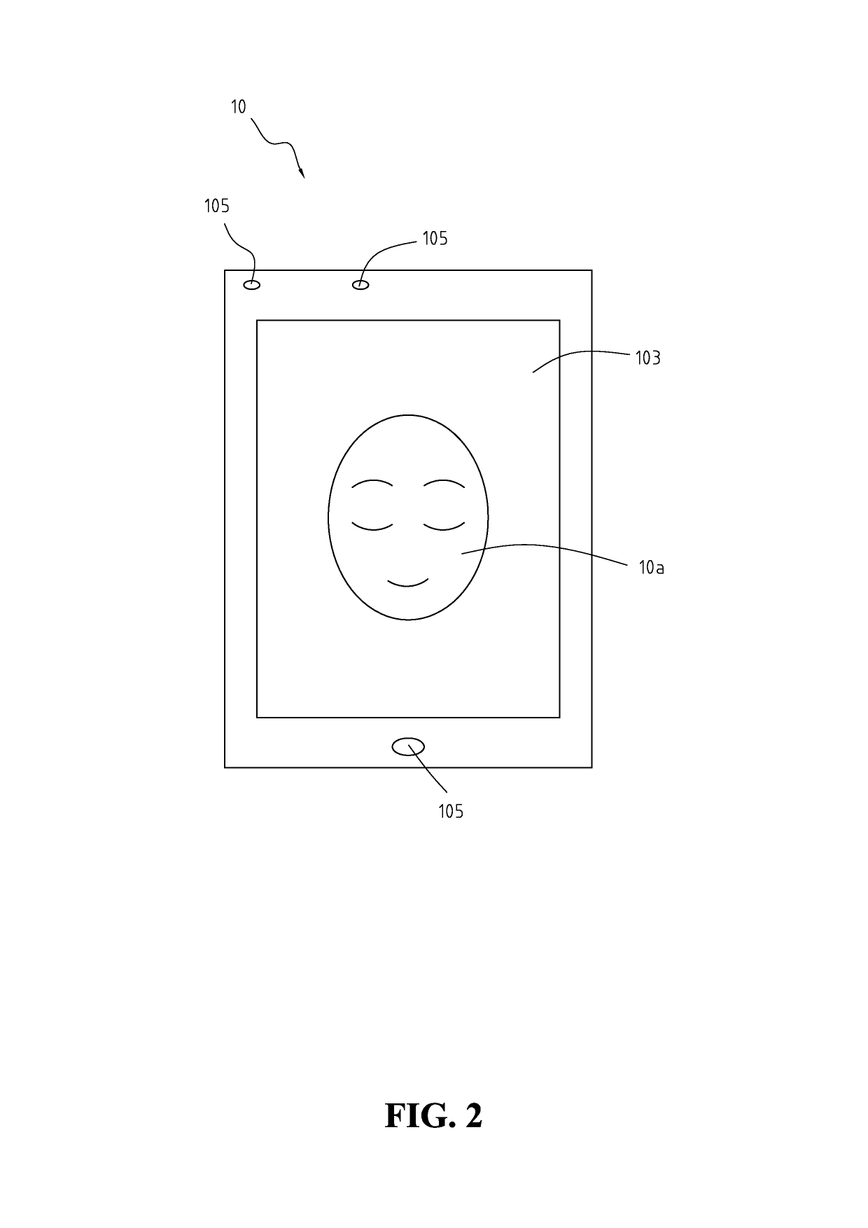

Referring to FIGS. 1, 2, 3, a method 30 for applying a virtual person is applicable to a plurality of portable electronic devices 10 according to the present invention, and the portable electronic devices 10 in the possession of their respective users are connected to a cloud server 20 via a communication chain 40. According to the present invention, the cloud server 20 mainly serves to execute a virtual person artificial intelligence simulation program 201. The virtual person artificial intelligence simulation program 201 is disclosed in the related prior art. The execution of the virtual person artificial intelligence simulation program 201 not only requires high-speed computational capacity, but also necessitates robust computational capacity, but neither of which is typical of the portable electronic device 10. Hence, the portable electronic device 10 needs the cloud server 20. To allow a user to perform the method 30 on the portable electronic device 10 according to the present invention, a display unit 103 of the portable electronic device 10 displays a virtual person 10a in a manner that, from the user's perspective, the virtual person 10a looks like an intimate friend of the user while the virtual person 10a is interacting with the user (for example, while the virtual person 10a is chatting, giving greetings, or responding to the user.)

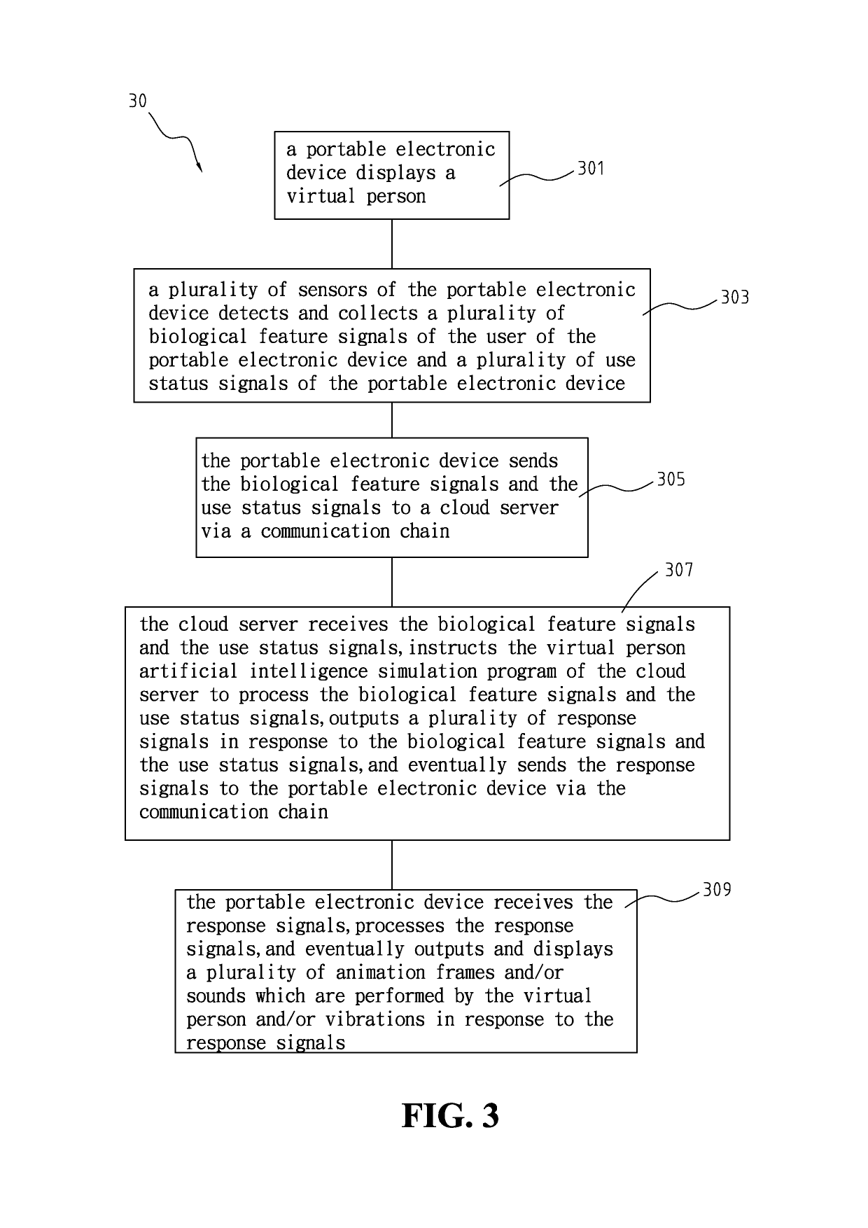

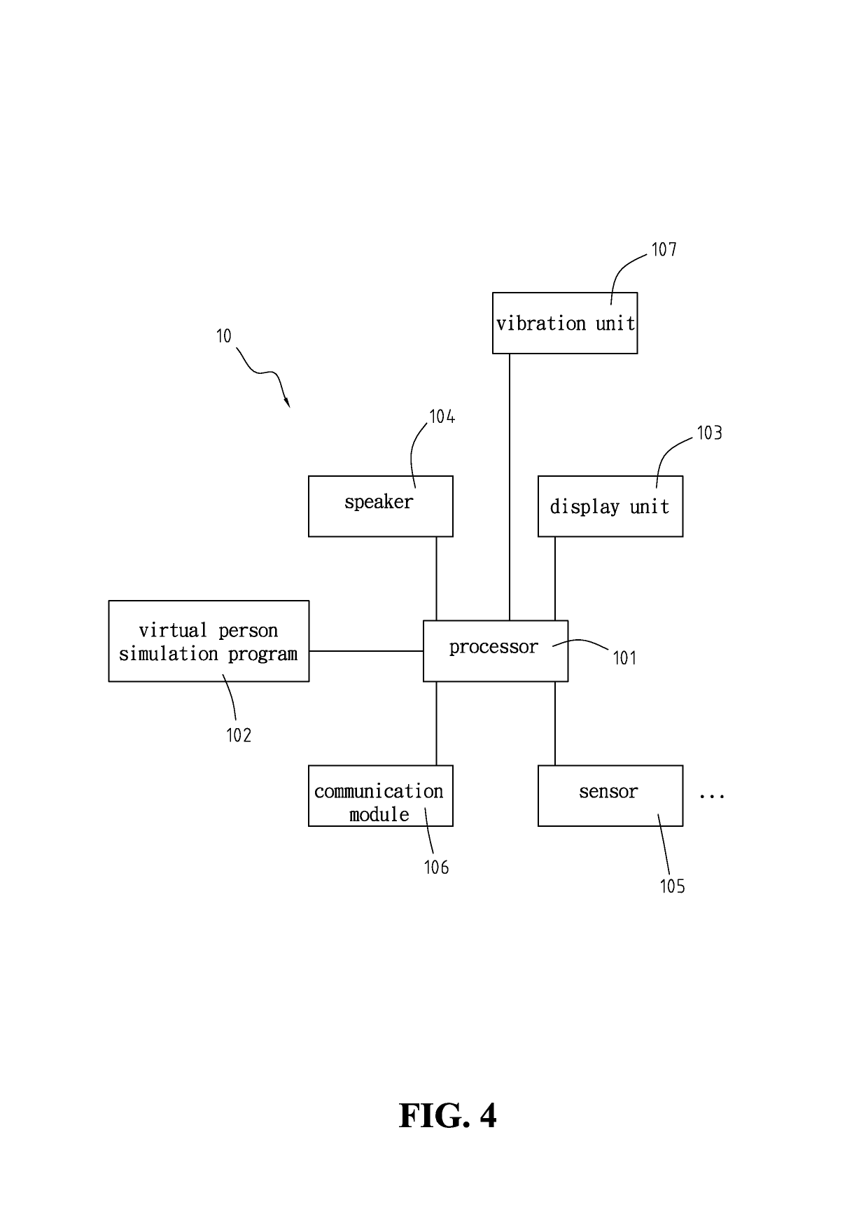

Referring to FIG. 3 and FIG. 4, the method 30 for applying a virtual person according to the present invention comprises steps 301˜309. A virtual person simulation program 102 is stored in a storage device of the portable electronic device 10. The virtual person simulation program 102 is for use in implementing the method 30 of the present invention specifically. For example, the storage device is a non-volatile semiconductor memory built in the portable electronic device 10, a memory card insertable into a memory card slot built in the portable electronic device 10, a USB flash drive, a hard disk drive (HDD), or a solid-state drive (SSD).

In step 301, the portable electronic device 10 displays the virtual person 10a. A processor 101 executes the virtual person simulation program 102, and then the display unit 103 displays the virtual person 10a. In the first instance of displaying the virtual person 10a, greetings, such as “how are you?” is sent to a speaker 104.

In step 303, a plurality of sensors 105 of the portable electronic device 10 detects and collects a plurality of biological feature signals 105a of the user of the portable electronic device 10 and a plurality of use status signals 105b of the portable electronic device 10. The processor 101 executes the virtual person simulation program 102 for starting the sensors 105. For example, the sensors 105 include an image capturing sensor, a microphone, a GPS receiver, a G-sensor, a temperature sensor, a pulse sensor, a touch panel sensor, a pressure detecting sensor, a light detecting sensor, or a combination thereof.

According to the present invention, the purpose of the image capturing sensor is to shoot a video or take a picture of the user's face, so as to obtain a biological facial imaging signal. A purpose of the microphone is to obtain a biological sound signal pertaining to the user's voice. Another purpose of the microphone is to obtain an ambient sound signal. A purpose of the temperature sensor is to obtain the user's biological body temperature signal (for example, the user's biological body temperature signal is indicative of the temperature of the user's palm in contact with the portable electronic device 10.) Another purpose of the temperature sensor is to obtain an ambient temperature signal. The purpose of the pulse sensor is to obtain the user's biological pulse signal. The purpose of the touch panel sensor is to obtain the user's emotional touch signal. The purpose of the pressure detecting sensor is to obtain an atmospheric pressure signal. The purpose of the light detecting sensor is to obtain an ambient light signal. The biological facial imaging signal, biological sound signal, biological body temperature signal, and biological pulse signal are specific examples of the biological feature signals 105a.

According to the present invention, the biological feature signals 105a are provided to the virtual person artificial intelligence simulation program 201 of the cloud server 20 to determine the user's current physiological state and psychological state.

The purpose of the GPS receiver is to obtain a GPS signal pertaining to the user's current geographical location. The purpose of the G-sensor is to obtain a G-signal pertaining to the portable electronic device 10 while the portable electronic device 10 is vibrating or shaking. The purpose of touch panel is to obtain user's fondling signal pertaining to the portable electronic device 10 while the portable electronic device 10 is touched. The GPS signal, G-signal, ambient sound signal, user's touching signal, ambient light signal, atmospheric pressure signal, and ambient temperature signal are specific examples of the use status signals 105b. According to the present invention, the use status signals 105b are provided to the virtual person artificial intelligence simulation program 201 of the cloud server 20 to help determine the user's current physiological state and psychological state, or to determine an ambient scenario in which the user happens to be present, so as to determine the user's current physiological state and psychological state accurately.

The sensors 105 are not restricted to the aforesaid specific examples, nor are the biological feature signals 105a and the use status signals 105b restricted to the aforesaid specific examples. Whatever changes made to the technical features described herein, such as increasing the sensors 105 or introducing other biological feature signals and use status signals, should be interpreted as falling within the equivalent scope of the present invention, as long as the changes do not depart from the spirit embodied in the method 30 of the present invention.

In step 305, the portable electronic device 10 sends the biological feature signals 105a and the use status signals 105b to the cloud server 20 via the communication chain 40. The processor 101 executes the virtual person simulation program 102 to thereby allow a communication module 106 to send the biological feature signals 105a and the use status signals 105b to the cloud server 20 via the communication chain 40. The communication module 106 is implemented according to the related prior art, and thus is, for example, a conventional WiFi-enabled communication module or a conventional 4G-enabled communication module.

In step 307, the cloud server 20 receives the biological feature signals 105a and the use status signals 105b, instructs the virtual person artificial intelligence simulation program 201 of the cloud server 20 to process the biological feature signals 105a and the use status signals 105b, outputs a plurality of response signals 203 in response to the biological feature signals 105a and the use status signals 105b, and eventually sends the response signals 203 to the portable electronic device 10 via the communication chain 40.

In step 307, which is executed in the cloud server 20, the portable electronic device 10 waits for the receipt of the response signals 203 during a period of time in which the cloud server 20 executes the virtual person artificial intelligence simulation program 201. The response signals 203 are transmitted by conventional packets in a network.

In step 309, the portable electronic device 10 receives the response signals 203, processes the response signals 203, and eventually outputs and displays a plurality of animation frames and/or sounds which are performed by the virtual person 10a and/or outputs vibrations in response to the response signals 203. The processor 101 executes the virtual person simulation program 102 to thereby allow the communication module 106 to receive the response signals 203 via the communication chain 40. Afterward, the virtual person simulation program 102 processes the response signals 203. Specific examples of the response signals 203 include vibrations and consecutive animation frames and sounds of the virtual person 10a which are sent to the user. The consecutive animation frames are displayed on the display unit 103. The sounds are transmitted to the speaker 104. The vibrations are transmitted to the vibration unit 107. Other specific examples of the response signals 203 include vibration signals, and light signals.

The portable electronic device 10 of the present invention is a smartphone, a smart TV, a tablet computer, a personal digital assistant (PDA), or a notebook computer.

Considering the spirit embodied in the present invention, the present invention can also be implemented by means of a desktop computer.

The portable electronic device 10 of the present invention makes good use of the robust computational capacity of the cloud server 20 in combining the sophisticated virtual person artificial intelligence simulation program 201 with the portable electronic device 10 delicately so as for the portable electronic device 10 to not only execute, seemingly on its own, the virtual person artificial intelligence simulation program 201 but also simulate a person alive and capable of interacting with users. Accordingly, the present invention involves an inventive step.

Hence, the present invention meets the three requirements of patentability, namely novelty, non-obviousness, and industrial applicability.

However, the aforesaid embodiment is illustrative of the present invention only, but should not be interpreted as restrictive of the scope of the present invention. Hence, all equivalent changes and modifications made to the claims and descriptions of the present invention should fall within the scope of the present invention.

What is claimed is:

1. A method for applying a virtual person and for use with a portable electronic device connected to a cloud server via a communication chain, wherein the cloud server executes a virtual person artificial intelligence simulation program, the method comprising the steps of:
displaying a virtual person by the portable electronic device;
detecting and collecting a plurality of biological feature signals of a user of the portable electronic device and a plurality of use status signals of the portable electronic device by a plurality of sensors of the portable electronic device;
sending, by the portable electronic device, the biological feature signals and the use status signals to the cloud server via the communication chain;
receiving the biological feature signals and the use status signals by the cloud server, processing the biological feature signals and the use status signals by the virtual person artificial intelligence simulation program of the cloud server, outputting a plurality of response signals in response to the biological feature signals and the use status signals, followed by sending, by the cloud server, the response signals to the portable electronic device via the communication chain; and
receiving and processing the response signals by the portable electronic device, followed by outputting and displaying, by the portable electronic device, a plurality of animation frames and/or sounds which are performed by the virtual person and/or a plurality of vibrations in response to the response signals.

2. The method of claim 1, wherein the portable electronic device is one of a smartphone, a tablet computer, a personal digital assistant (PDA), a smart TV, and a notebook computer.

3. The method of claim 1, wherein the sensors of the portable electronic device include an image capturing sensor, a microphone, a GPS receiver, a G-sensor, a temperature sensor, a pulse sensor, a light detecting sensor, a touch panel sensor, a pressure sensor, or a combination thereof.

4. The method of claim 1, wherein the biological feature signals include a biological sound signal, a biological body temperature signal, a biological pulse signal, a biological facial imaging signal, or a combination thereof, and the use status signals include an ambient sound signal, an ambient temperature signal, a GPS signal, a G-signal, a light signal, a touching signal, a pressure signal, or a combination thereof.

5. A portable electronic device, comprising:
a plurality of sensors;
a display unit, a vibration unit and a speaker;
a communication module for connection with a communication chain;
a virtual person simulation program; and
a processor for executing the virtual person simulation program to thereby perform the steps of:
displaying a virtual person on the display unit;
detecting and collecting a plurality of biological feature signals of a user of the portable electronic device and a plurality of use status signals of the portable electronic device by the sensors;
sending, by the communication module, the biological feature signals and the use status signals to a cloud server to thereby allow the cloud server to receive the biological feature signals and the biological feature signals, such that a virtual person artificial intelligence simulation program of the cloud server processes the biological feature signals and the use status signals before outputting a plurality of response signals in response to the biological feature signals and the use status signals, and then the cloud server sends the response signals to the portable electronic device via the communication chain; and
receiving and processing the response signals by the communication module, followed by displaying on the display unit a plurality of animation frames which are performed by the virtual person in response to the response signals, and/or outputting a sound from the speaker, and/or outputting a vibration from the vibration unit.

6. The portable electronic device of claim 5, wherein the portable electronic device is one of a smartphone, a tablet computer, a personal digital assistant (PDA), a smart TV, and a notebook computer.

7. The portable electronic device of claim 5, wherein the sensors include an image capturing sensor, a microphone, a GPS receiver, a G-sensor, a temperature sensor, a pulse sensor, a light detecting sensor, a touch panel sensor, a pressure sensor, or a combination thereof.

8. The portable electronic device of claim 5, wherein the biological feature signals include a biological sound signal, a biological body temperature signal, a biological pulse signal, a biological facial imaging signal, or a combination thereof, and the use status signals include an ambient sound signal, an ambient temperature signal, a user's touching signal, an ambient light signal, an atmospheric pressure signal, a GPS signal, a G-signal, or a combination thereof.

9. A computer device, comprising:
a plurality of sensors;
a display unit, a vibration unit and a speaker;
a communication module for connection with a communication chain;
a virtual person simulation program;
a processor for executing the virtual person simulation program to thereby perform the steps of:
displaying a virtual person on the display unit;
detecting and collecting a plurality of biological feature signals of a user of the computer device and a plurality of use status signals of the computer device by the sensors;
sending, by the communication module, the biological feature signals and the use status signals to a cloud server to thereby allow the cloud server to receive the biological feature signals and the use status signals, such that a virtual person artificial intelligence simulation program of the cloud server processes the biological feature signals and the use status signals before outputting a plurality of response signals in response to the biological feature signals and the use status signals, and then the cloud server sends the response signals to the computer device via the communication chain; and
receiving and processing the response signals by the communication module, followed by displaying on the display unit a plurality of animation frames which are performed by the virtual person in response to the response signals, and/or outputting a sound from the speaker, and/or outputting a vibration from the vibration unit.

10. The computer device of claim 9, wherein the computer device is a desktop computer.
